(19) United States
(12) Patent Application Publication
(10) Pub. No.: US 2006/0235344 A1
(43) Pub. Date: Oct. 19, 2006

(54) Portable multi-function exercise apparatus

(76) Inventor: Chin-Sheng Tu, San Jose, CA (US)

Correspondence Address: CHEIN-HWA S. TSAO, 6684 MT PAKRON DRIVE, SAN JOSE, CA, 95120, US

(21) Appl. No.: 11/110,152

(22) Filed: Apr. 19, 2005

(51) Int. Cl. A61H 7/00

(52) U.S. Cl. 601/135; 601/137

(57) ABSTRACT

A portable exercise apparatus for exercise and massaging is proposed. The apparatus includes a handled massager body with massaging nodules. At least two handles are provided for engagement with a user's body to facilitate exercise and massaging. An elastic attachment mechanism is provided at the handle ends. The end of the attachment mechanism includes an eye loop for removably attaching flexible links. The other end of the flexible link includes an object-engaging structure for engaging a user's body or another object to facilitate body exercise and massaging. The attachment mechanism can also be made rotatable with respect to the handled massager body for a rolling massaging movement. The handled massager body can be further made hollow and sectioned for removably housing the attachment mechanism. Hence a number of attachment mechanisms can be interchanged for achieving body exercise and massaging with a wide range of intensity.

### CROSS REFERENCE TO RELATED APPLICATION

### BACKGROUND OF THE INVENTION

1. Field of the Invention

The present invention relates generally to the field of health-enhancing apparatus. More particularity, the present invention is directed to a portable multi-function exercise apparatus for body exercise and massaging.

2. Description of the Related Art

Numerous health-enhancing apparatus have existed and have been continuously expanding in the market to suit a variety of human health needs. A number of common desires leading the further development of health-enhancing apparatus are functional flexibility, compactness and portability.

### SUMMARY OF THE INVENTION

A portable multi-function exercise apparatus for body exercise and massaging is proposed to satisfy the aforementioned common desires of the health-enhancing apparatus market.

The portable multi-function exercise apparatus includes a handled massager body having a body portion and a handle portion. The body portion has a number of nodules for massaging a user's body part. The handle portion includes at least two handles each having a free end and a body end. The body end is connected to the body portion. Upon their engagement with a predetermined user's body part, the handles work to facilitate body exercise and massaging.

In one embodiment, the body portion has eight nodules forming a surface contour approximating the shape of a shortened humerus bone and the handle portion has two substantially cylindrical-shaped handles connected to two opposite ends of the body portion.

In another embodiment, an elastically extendable end attachment mechanism is provided at the free end of both handles and the free end of the elastically extendable end attachment mechanism in turn includes an eye loop for removably attaching a first end of one or more flexible linking member. The second end of the flexible linking member includes an external object-engaging structure for engaging a user's body part or another external object to facilitate additional body exercise and massaging.

In yet another embodiment, the elastically extendable end attachment mechanism is designed to be rotatable with respect to the handled massager body around its longitudinal axis so that, upon positioning the handled massager body upon a user's body part while maneuvering the eye loops, the user can massage the body part with a resulting rolling movement of the handled massager body.

In yet another embodiment, the handled massager body is made hollow and further sectioned into a number of separable massager body subsections for enclosing the elastically extendable end attachment mechanisms. This allows the interchange of a number of elastically extendable end attachment mechanisms each exhibiting a corresponding desired range of elasticity for achieving body exercise and massaging with a wide range of intensity.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts throughout the several views, and wherein:

FIG. 1A is an exterior perspective illustration of the handled massager body portion of the portable multi-function exercise apparatus of the present invention;

FIG. 1B is a sectioned perspective illustration of the handled massager body portion of the portable multi-function exercise apparatus of the present invention;

FIG. 2 is an exterior perspective illustration of the portable multi-function exercise apparatus of the present invention;

FIG. 3A to FIG. 4C are a series of figures illustrating numerous ways of using the handled massager body portion of the portable multi-function exercise apparatus for corresponding health benefits; and

FIG. 5A to FIG. 7B are another series of figures illustrating numerous ways of using the portable multi-function exercise apparatus for corresponding health benefits.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials and components have not been described in detail to avoid unnecessary obscuring aspects of the present invention. The detailed description is presented largely in terms of simplified perspective views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

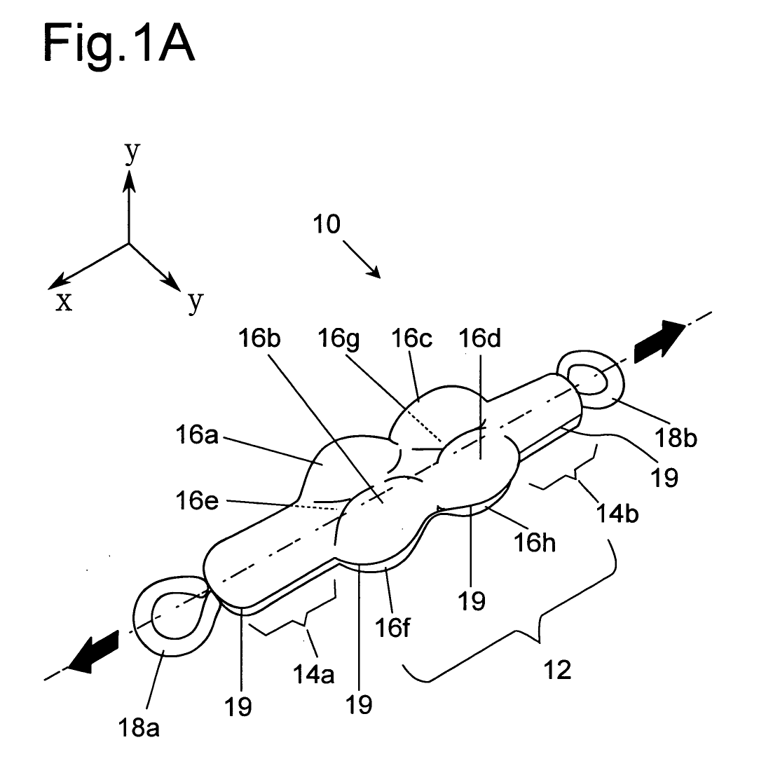

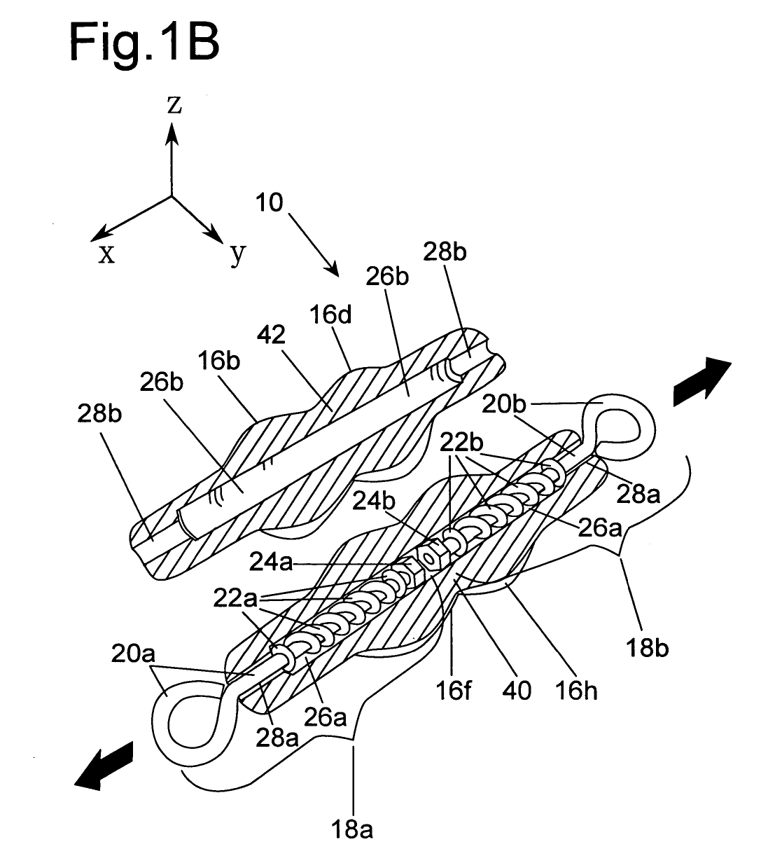

FIG. 1A is an exterior perspective illustration of the handled massager body 10 portion of the portable multi-function exercise apparatus of the present invention. The handled massager body 10 has a body portion 12 and two opposite handles 14a and 14b. Except for the round off of their free ends, the two handles 14a and 14b are both substantially cylindrical in shape. In this preferred embodiment, the body portion 12 is shown to have eight nodules 16a, 16b, 16c, 16d, 16e, 16f, 16g and 16h for, upon their contacting a user's body part either individually or jointly, massaging the body part and these will be presently illustrated. Notice that, with the eight nodules 16a-16h, the surface contour of the body portion 12 resembles the shape of a shortened human humerus bone. Each of the two handles 14a and 14b has a free end and a body end with the body end connected to a corresponding part of the body portion 12. Upon their engagement with a predetermined user's body part in a prescribed manner, the two handles 14a and 14b further facilitate a corresponding body exercise and massaging and these will also be presently illustrated. For the attachment of additional components to the handled massager body 10, an end attachment mechanism 18a and an end attachment mechanism 18b, with their visible portion seen as two eye loops, are also provided at the free ends of the two handles 14a and 14b as part of the handled massager body 10. Notice that both of the two eye loops, by way of the detailed design of the two end attachment mechanisms 18a and 18b to be presently described, are extendable along the X-axis with respect to the handled massager body 10 and this is signified with the two arrows. For additional flexibility, the handled massager body 10 is made hollow and includes two separable, upper and lower massager body subsections joined along a sectional seam line 19.

FIG. 1B is a sectioned, with an upper massager body subsection 42 and a lower massager body subsection 40, perspective illustration of the handled massager body 10 portion of the portable multi-function exercise apparatus. Notice that the handled massager body 10 is made hollow plus the upper massager body subsection 42 and the lower massager body subsection 40 are separable. However, to avoid obscuring details, various mechanical locking features holding the upper massager body subsection 42 and the lower massager body subsection 40 together to form the handled massager body 10 are not shown here. Besides having the visible nodule 16f and nodule 16h, the lower massager body subsection 40 houses the two elastically extendable end attachment mechanism 18a and end attachment mechanism 18b with a built-in center groove 26a plus two end grooves 28a along the X-axis. Correspondingly, upper massager body subsection 42 has a center groove 26b plus two end grooves 28b in addition to having the visible nodule 16b and nodule 16d. The end attachment mechanism 18a has a threaded rod with end hook 20a, a lock nut 24a threaded thus affixed to the inner end of the threaded rod with end hook 20a and an interposing compression spring 22a axially embracing the threaded rod with end hook 20a. Notice that the compression spring 22a is also trapped between the lock nut 24a and a step interface between the end groove 28a and the center groove 26a. Thus, under the action of the compression spring 22a, the end attachment mechanism 18a becomes elastically extendable along the X-direction as indicated by a so pointed arrow.

Furthermore, by selecting a different end attachment mechanism 18a wherein the selected compression spring 22a has another value for its spring constant, the different end attachment mechanism 18a will exhibit a correspondingly desired range of elasticity for its extension along the X-direction. Additionally, the eye loop of the threaded rod with end hook 20a can be used for attaching, in a manner allowing a later removal and/or exchange, various objects for further function and this will be presently described. As the end attachment mechanism 18a together with the end groove 28b and the center groove 26b are all structurally essentially axisymmetric with respect to the X-axis, the end attachment mechanism 18a is also rotatable with respect to the handled massager body 10 around its longitudinal axis for additional function and this will also be presently described.

For those skilled in the art, numerous variations to the as-illustrated structure of the end attachment mechanism 18a exist that still accomplish the aforementioned functions. For example, the lock nut 24a can be replaced with a snap-on end cap so affixed onto the threaded rod with end hook 20a through mechanical interference. For another example, the lock nut 24a can be enlarged to anchor into a correspondingly enlarged local annular groove of the center groove 26b to stop any X-direction movement, the compression spring 22a can be replaced with an extension spring with its inner end permanently affixed to the enlarged lock nut while the inner end of the threaded rod with end hook 20a gets shortened and permanently affixed to the outer end of the extension spring. Yet another example would be to replace the complete compression spring 22a, lock nut 24a assembly with a pneumatically-operated piston using either gas or fluid as its elastic medium. Except for facing the negative X-direction, the various components of lock nut 24b, compression spring 22b and threaded rod with end hook 20b of the end attachment mechanism 18b, housed within the center groove 26a and an end groove 28a of the massager body subsection 40, are the same as those of the end attachment mechanism 18a.

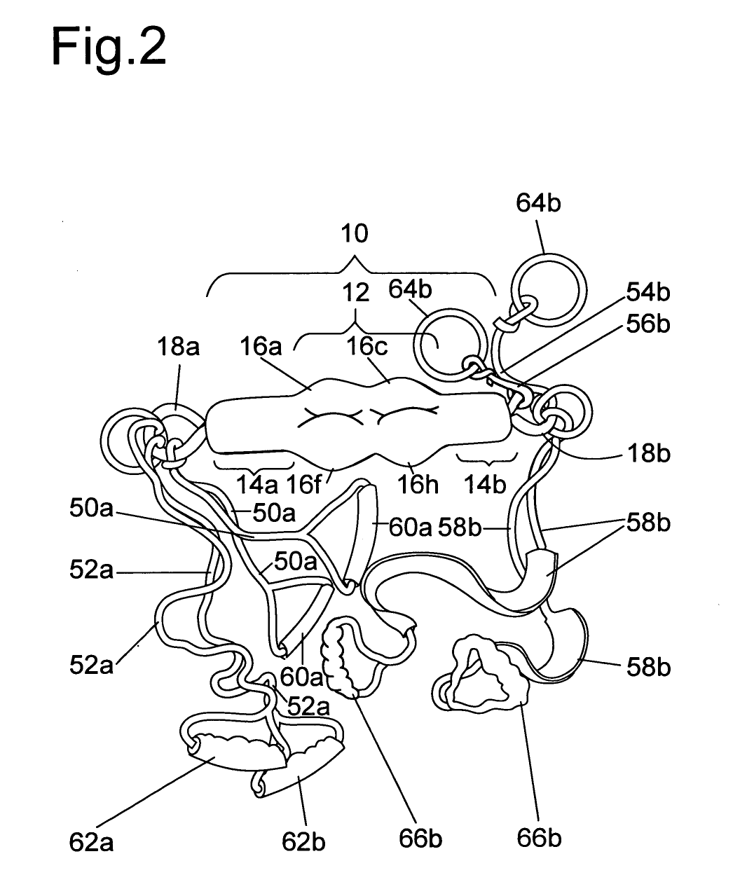

FIG. 2 is an exterior perspective illustration of the portable multi-function exercise apparatus of the present invention. At the free end of the handle 14a, one or more flexible linking members can be attached to the end attachment mechanism 18a in a manner allowing a later removal and/or exchange. These flexible linking members are 50a and 52a. The second end of these flexible linking members further includes an external object-engaging loop for, upon its engagement with a body part or an external object in a prescribed manner as will be presently described, facilitating body exercise and massaging. The external object-engaging loops are 60a and 62a. Likewise, at the free end of the other handle 14b, one or more flexible linking members 56b and 58b can be attached to the end attachment mechanism 18b in a manner allowing a later removal and/or exchange. The second end of these flexible linking members further includes external object-engaging loops 64b and 66b for, upon their engagement with a body part or an external object in a prescribed manner as will be presently described, facilitating body exercise and massaging.

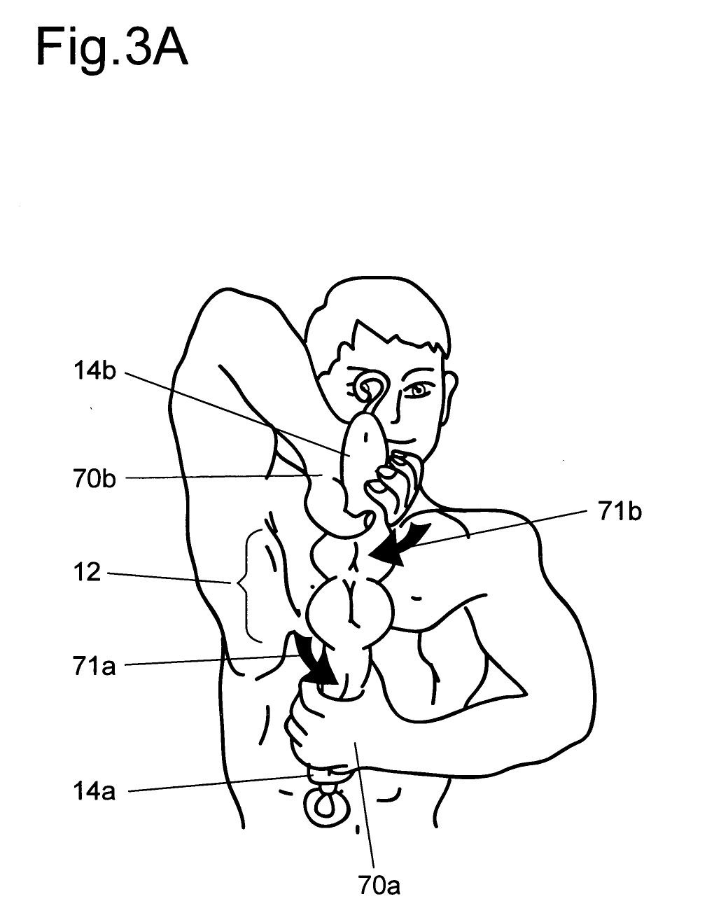

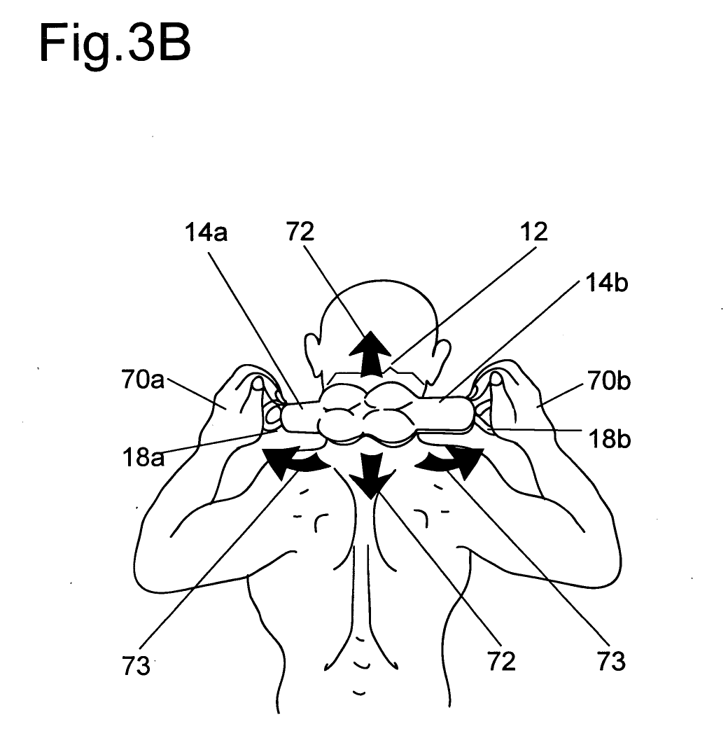

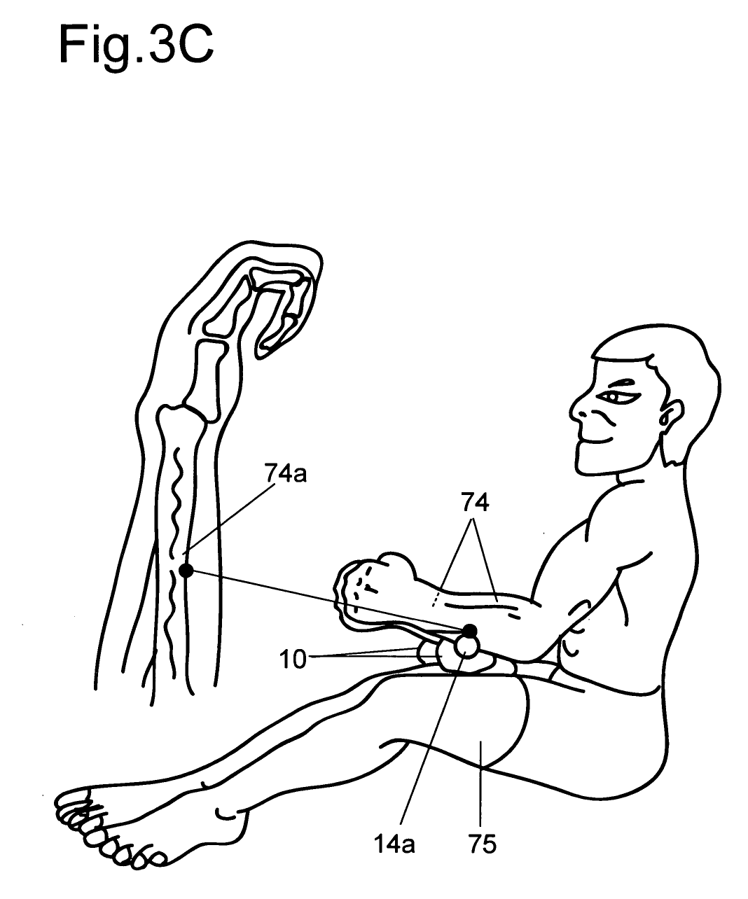

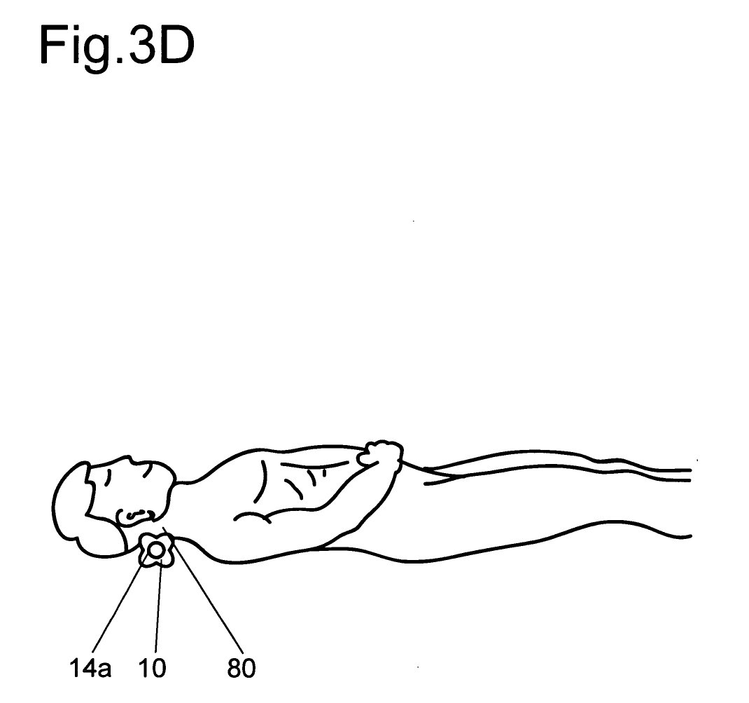

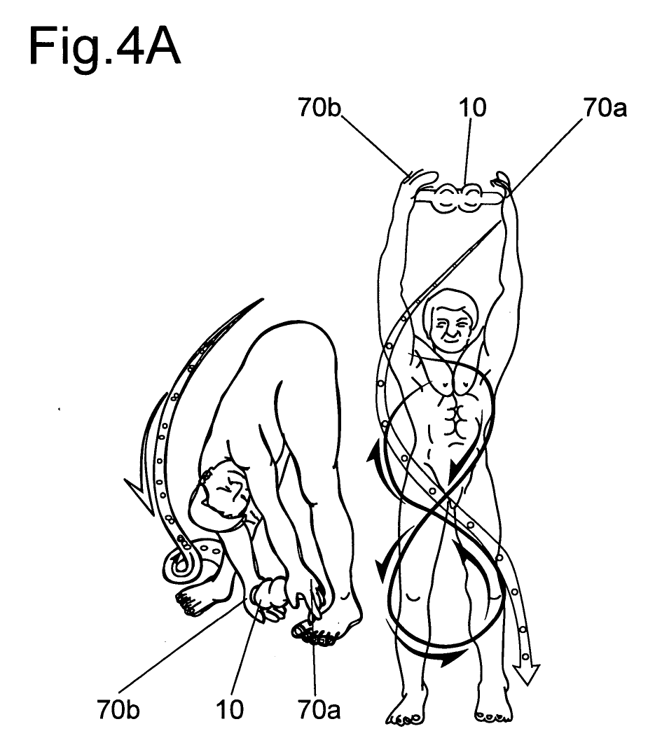

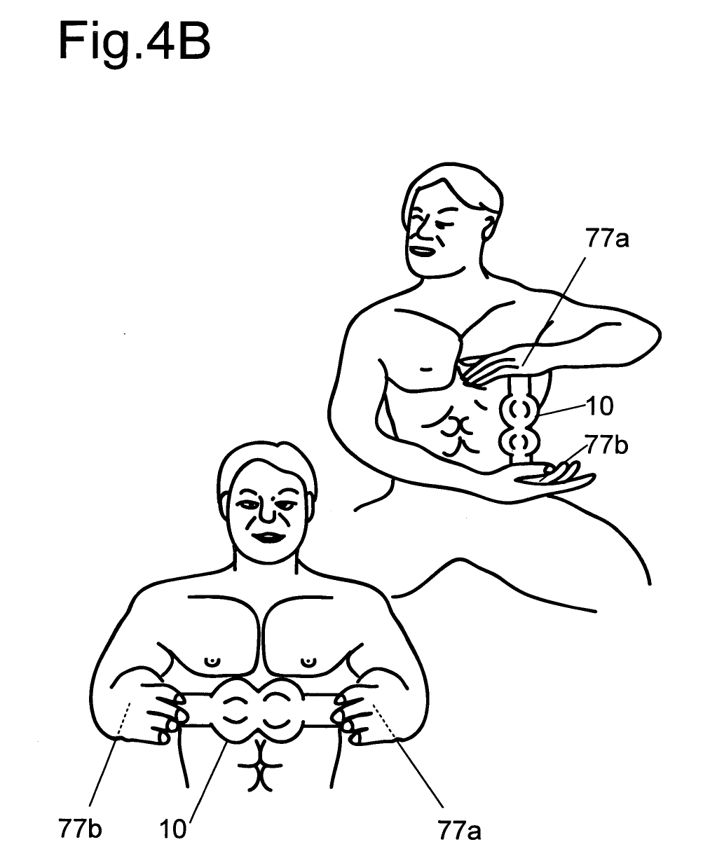

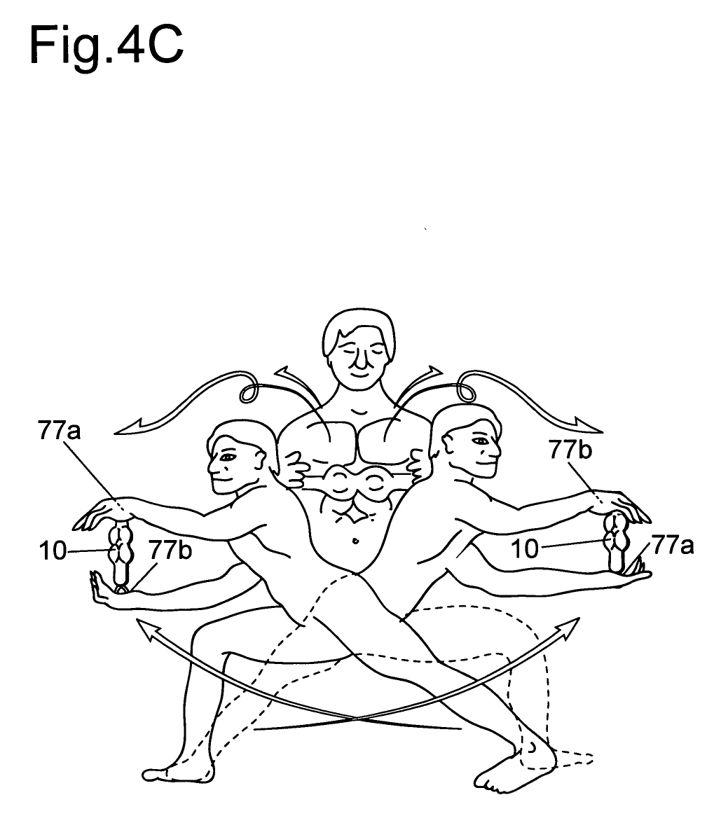

FIG. 3A to FIG. 4C are a series of figures illustrating numerous ways of using the handled massager body 10 portion of the portable multi-function exercise apparatus for corresponding health benefits.

In an exercise depicted in FIG. 3A, an exerciser's left hand 70a and right hand 70b respectively grips the handles 14a and 14b while twisting the left hand 70a in a left hand twisting direction 71a and the right hand 70b in a right hand twisting direction 71b. The corresponding health benefit includes strengthening the user's gripping power and wrists.

In FIG. 3B, an exerciser presses firmly onto the ends of the handled massager body 10 with his left hand 70a against the end attachment mechanism 18a and his right hand 70b against the end attachment mechanism 18b. Simultaneously, the exerciser pushes the handled massager body 10 up and down and against his neck with a rolling vertical massaging directions 72, or alternatively with a rolling horizontal massaging directions 73, so as to massage his cervical vertebrae with the nodules 16a, 16b, 16c, 16d, 16e, 16f, 16g and 16h of the handled massager body 10. With further reach downwards, his upper back can also be massaged. While not shown here, it should become clear by now that these nodules of the handled massager body 10 can be used to massage many other parts of the body. For example, the spinal area near the waist, together with the kidneys can be massaged. Additional areas include the chest, the abdomen, the inside and outside muscle and bone areas of the upper and lower legs.

In FIG. 3C, an exerciser presses the handled massager body with his lower arms 74 and upper legs 75. Simultaneously, the exerciser pushes and rolls the handled massager body 10 in a substantially horizontal direction to massage his radius of the forearm 74a. The benefits include strengthening his arms and, indirectly, revitalizing his cardiovascular system. It is remarked here that, while eight nodules 16a, 16b, 16c, 16d, 16e, 16f, 16g and 16h are presented here, the handled massager body 10 can alternatively have other numbers of nodules as well. It should also be noticed that the handled massager body 10 can be made of a wide variety of materials, such as wood, plastic, leather, ceramic, stone or metal.

In FIG. 3D, an exerciser simply rests his back neck against the handled massager body 10 to physically adjust his cervical vertebrae 80.

In FIG. 4A, while firmly holding the handled massager body 10 with his left hand 70a and right hand 70b, the exerciser engages in a soft, full-body “FIG. 8” shaped Tai-Chi movement to strengthen his whole spine.

In FIG. 4B and FIG. 4C, while firmly pressing the handled massager body 10 between his left palm 77a and right palm 77b, the exerciser engages in the depicted trajectories of soft Tai-Chi movement with a synchronized breathing to adjust his whole body joints.

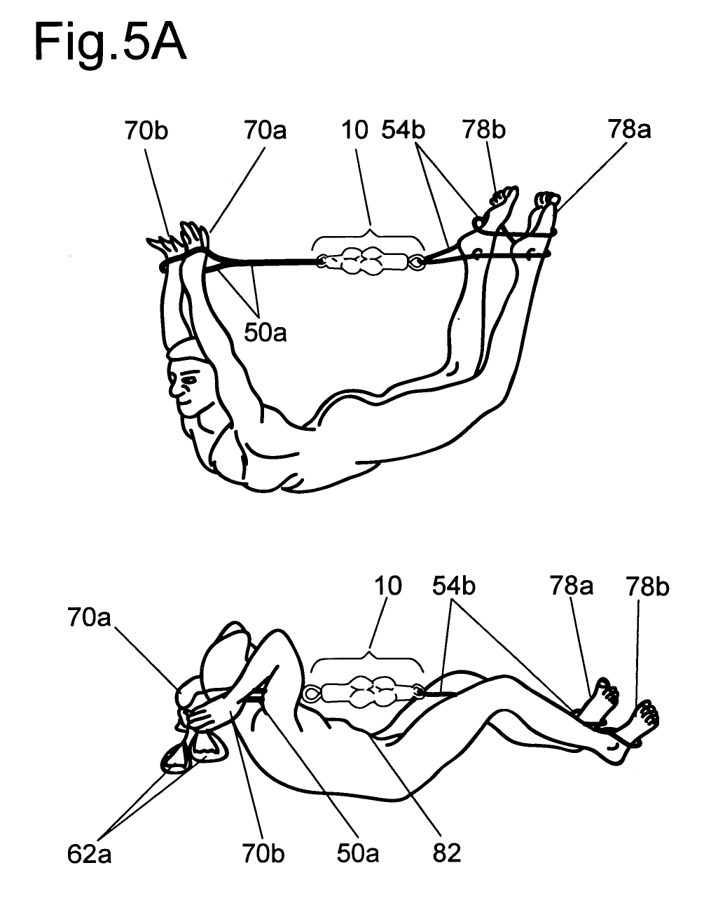

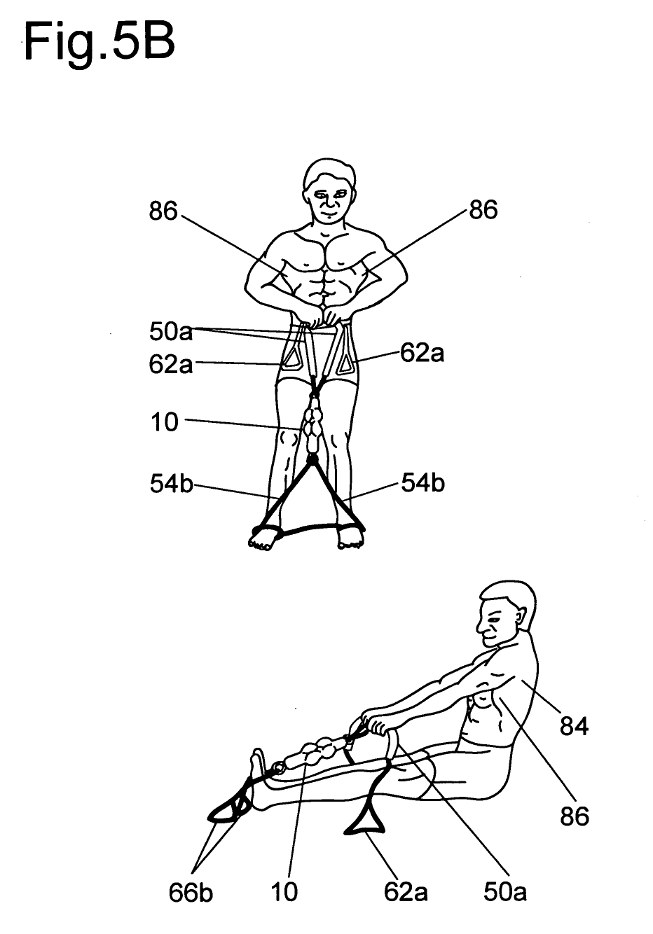

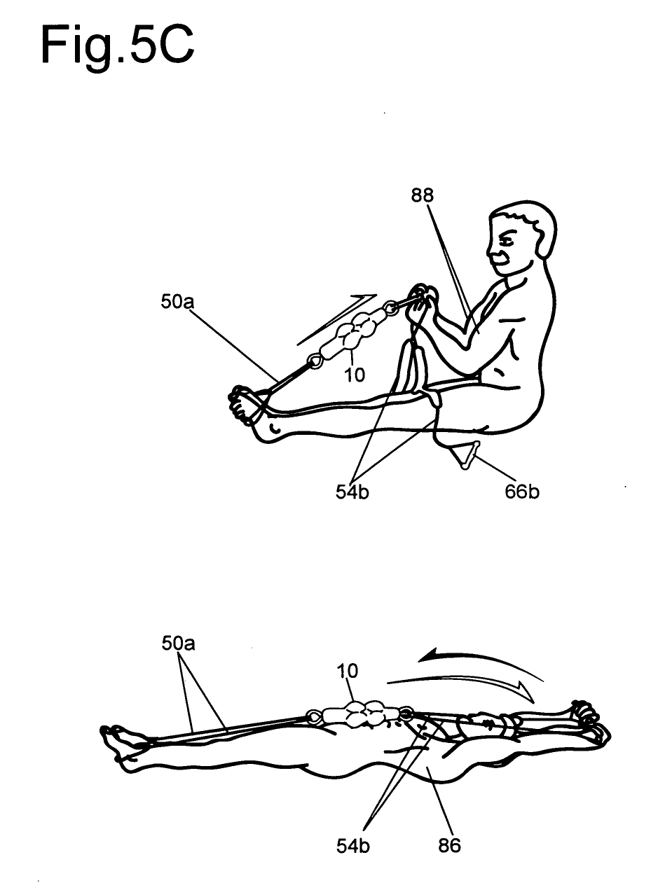

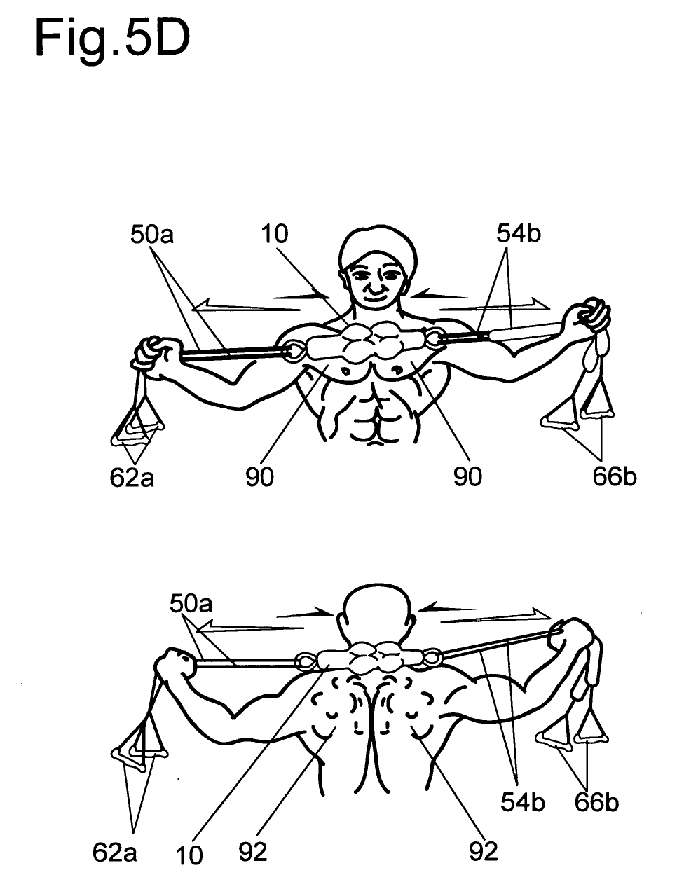

FIG. 5A to FIG. 7B are another series of figures illustrating numerous ways of using the portable multi-function exercise apparatus for corresponding health benefits.

In the top half of FIG. 5A, after lying down on his chest, the exerciser reaches back to engage his left hand 70a and right hand 70b with one flexible linking member 50a while simultaneously lifting his left foot 78a and right foot 78b to engage the other flexible linking member 54b. In this way, a full body stretching is realized with special emphasis on strengthening the back muscle. As remarked before, selecting different end attachment mechanism 18a results in a correspondingly desired range of elasticity. Here, this means stretching the full body can be accomplished with a wide range of desired intensity. Clearly, this remark should apply to any of the following exercises wherein either the end attachment mechanisms or the flexible linking members are stretched. Except for lying down on his back, the exercise depicted in the bottom half of FIG. 5A is similar albeit for the special emphasis on strengthening the rectus abdominus 82.

In the top half of FIG. 5B, the exerciser engages the flexible linking member 54b with his feet. While standing up, the exerciser also strenuously pulls the other flexible linking member 50a upwards to simultaneously exercise his rhomboidus major 84, upper arms, lower arms and to strengthen his teres major 86. Except for a sitting down position, the exercise of the bottom half of FIG. 5B offers similar health benefit with the added action of acupressuring the bottom of his feet.

The exercise of FIG. 5C illustrates, after engaging one flexible linking member 50a with his feet and the other flexible linking member 54b with his hands, a user performs a sit up movement while strenuously stretching the portable multi-function exercise apparatus of the present invention to strengthen his biceps brachii 88 and teres major 86.

In the top half of FIG. 5D, the exerciser horizontally stretches the portable multi-function exercise apparatus of the present invention across his chest via the flexible linking member 54b and the flexible linking member 50a with his hands. The primary benefit is to strengthen his pectoralis major 90. Except for the placement of the portable multi-function exercise apparatus across the back neck, the exercise of the bottom half of FIG. 5D is similar with the primary benefit of strengthening his latissimus dorsi 92.

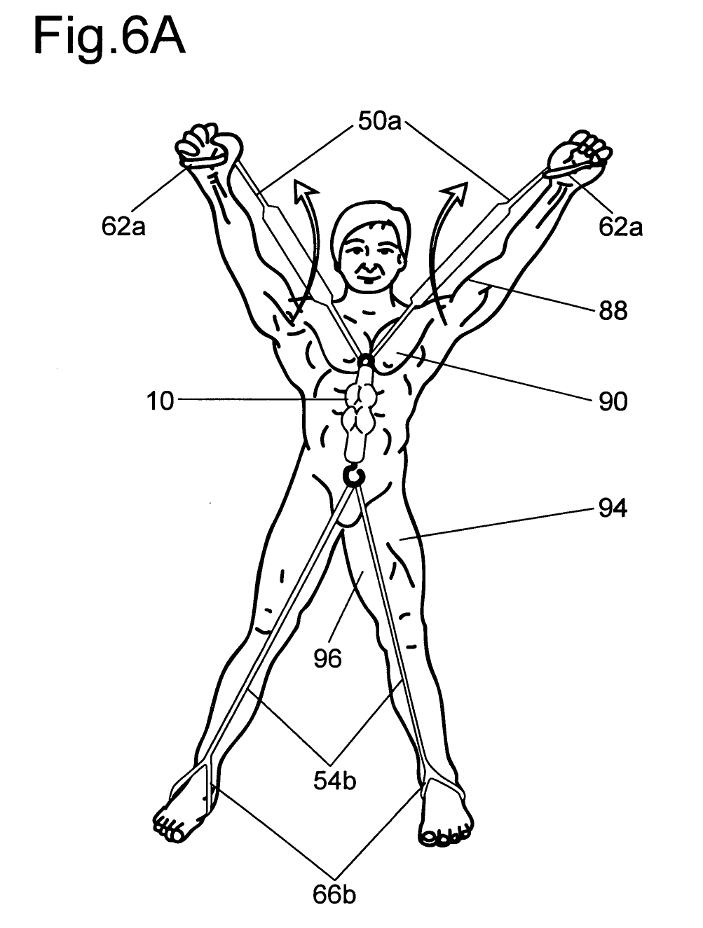

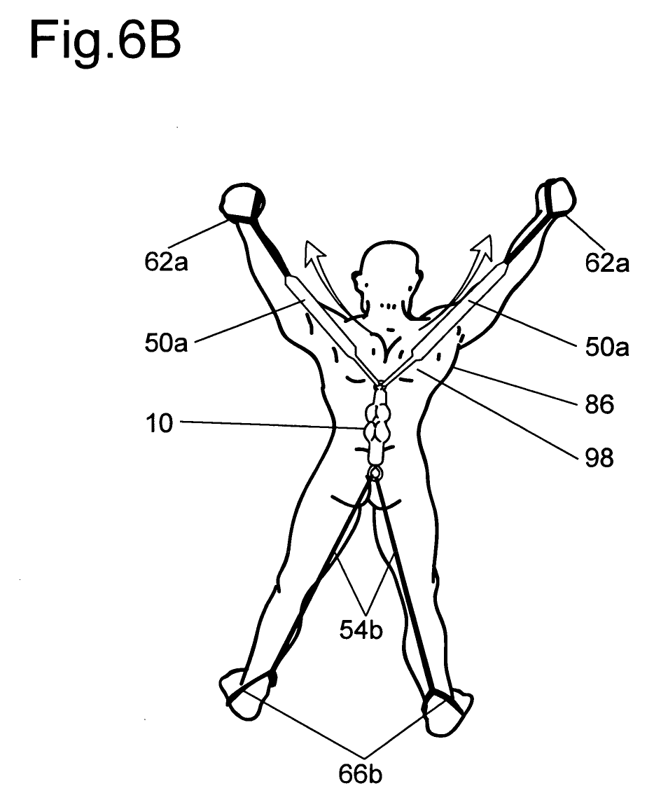

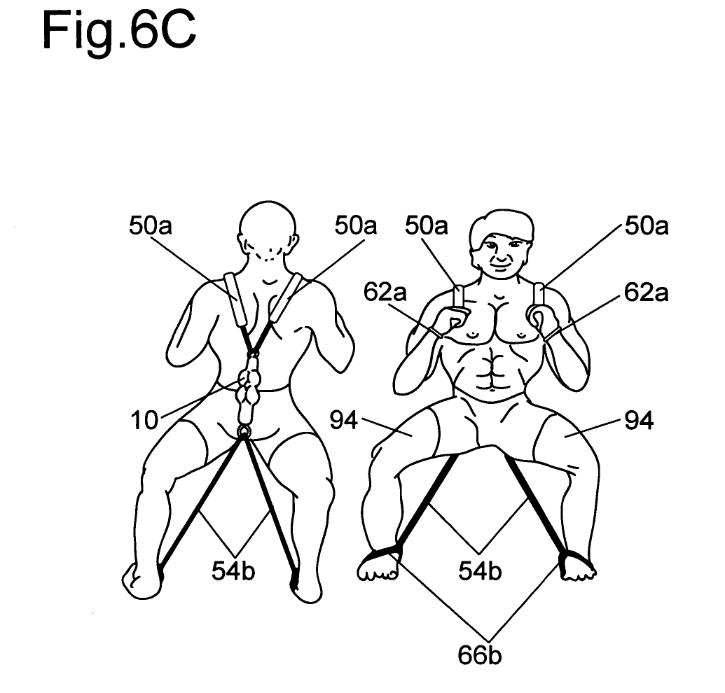

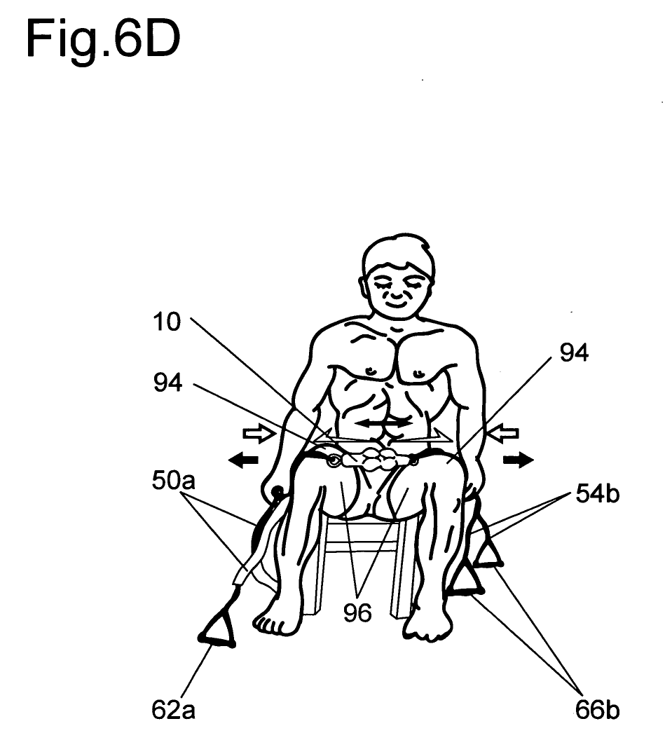

The exercise of FIG. 6A illustrates, after engaging the external object-engaging loops 66b with his feet and the external object-engaging loops 62a with his hands, a user performs a full body stretch together with the portable multi-function exercise apparatus in front of him while standing up and spreading his hands and feet. This is to strengthen his body muscles like adductor longus 96, rectus femois 94 and biceps brachii 88 with emphasis on his pectoralis major 90.

Except for the placement of the portable multi-function exercise apparatus behind the user, the exercise of FIG. 6B is similar to that of FIG. 6A with emphasis on his rhomboidus major 98 and teres major 86.

The exercise of FIG. 6C illustrates, after assuming a posture with half-bent knees while engaging the external object-engaging loops 66b with his feet and with the portable multi-function exercise apparatus placed behind his back, the user strenuously pulls the flexible linking members 50a to strap them cross his shoulders from the back to the front. This is to primarily strengthen his rectus femois 94.

The exercise of FIG. 6D illustrates, after sitting on a stool with the portable multi-function exercise apparatus placed upon his upper legs, the user strenuously while intermittently stretches the flexible linking members 50a and 54b to primarily strengthen his rectus femois 94 and adductor longus 96.

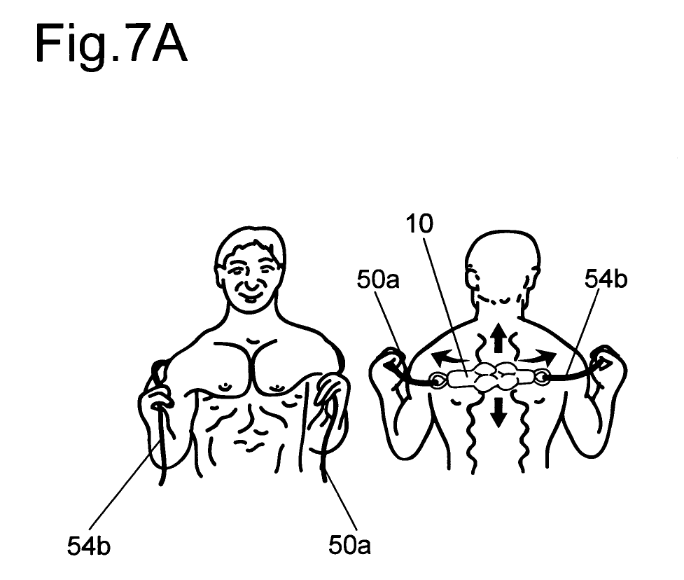

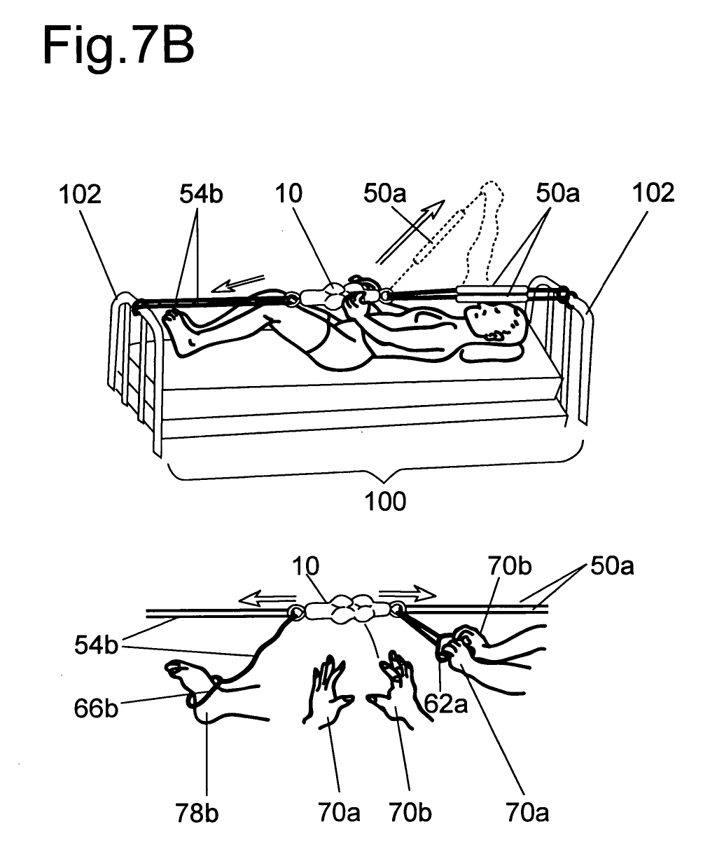

In FIG. 7A, an exerciser firmly presses the handled massager body 10 across and against his back while tightly stretching the flexible linking members 50a and 54b from the sides. Simultaneously, the user maneuvers the handled massager body 10 up and down and against his back with a rolling vertical massaging direction, or alternatively with a rolling horizontal massaging direction, so as to massage his back with the nodules 16a, 16b, 16c, 16d, 16e, 16f, 16g and 16h of the handled massager body 10.

In the top half of FIG. 7B, the portable multi-function exercise apparatus is pre-stretched, via the flexible linking members 54b and 50a, across the bed frames 102 of a bed 100 on which a user lies. In this embodiment, the user can be a patient using the multi-function exercise apparatus as part of his physical therapy. The patient can then strenuously stretch one of the flexible linking members 50a upwards with his right hand for a corresponding exercise, etc. In the bottom half of FIG. 7B, the user can engage the external object-engaging loop 66b with his right foot 78b then cyclically stretching the multi-function exercise apparatus to exercise. The user can also grab the handled massager body 10 with either one or both of his left hand 70a and right hand 70b then cyclically pulls it to exercise. Alternatively, the user can also grab the external object-engaging loop 62a with both of his hands then cyclically pulls it for a corresponding exercise of his hands and arms.

As described with numerous exemplary embodiments, a portable multi-function exercise apparatus is proposed to enable its user to carry out a wide variety of health-enhancing body exercises and massages. However, for those skilled in this field, these exemplary embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed is:

1. A portable multi-function exercise apparatus for body exercise and massaging, the exercise apparatus comprises a handled massager body having a body portion and a handle portion wherein:
(a) said body portion further comprises at least one nodule for, upon its contacting a body part, massaging the body part; and
(b) said handle portion further comprises at least two handles, each having a free end and a body end with said body end connected to a corresponding part of said body portion, said at least two handles for, upon their engagement with a predetermined body part in a prescribed manner, facilitating said body exercise and massaging.

2. The exercise apparatus of claim 1 wherein said body portion further comprises eight nodules located thereon thereby forming a surface contour of said body portion approximating the shape of a shortened humerus bone.

3. The exercise apparatus of claim 1 wherein said handle portion further comprises two handles both having a substantially cylindrical shape and connected to two opposite ends of said body portion.

4. The exercise apparatus of claim 1 wherein said handled massager body is made of wood, plastic, leather, ceramic, stone or metal.

5. The exercise apparatus of claim 1 wherein the free end of each of said at least two handles further comprises an elastically extendable end attachment means for removably attaching a first end of at least one flexible linking member thereto.

6. The exercise apparatus of claim 5 wherein, for attaching the first end of said at least one flexible linking member, the free end of each of said elastically extendable end attachment means further comprises an eye loop.

7. The exercise apparatus of claim 6 wherein said elastically extendable end attachment means is further made rotatable with respect to said handled massager body around its longitudinal axis whereby, upon positioning said handled massager body upon a body part while maneuvering said eye loops by a user, the user can massage the corresponding body part with a resulting rolling movement of said handled massager body.

8. The exercise apparatus of claim 5 further comprises, at the free end of each of said at least two handles, at least one of said flexible linking member whose second end further comprises an external object-engaging means for, upon its engagement with a predetermined body part or an external object in a prescribed manner, facilitating additional body exercise and massaging.

9. The exercise apparatus of claim 5 wherein said handled massager body is made hollow and further comprises a number of separable massager body subsections whereby allowing the interchange of a number of elastically extendable end attachment means each exhibiting a corresponding desired range of elasticity for achieving body exercise and massaging with a wide range of intensity.

10. A method of exercising and massaging the body of a user, the method comprises:
(a) providing a handled massager body having a body portion and a handle portion wherein said body portion further comprises at least one nodules for massaging a body part upon their engagement with said body part;
(b) engaging said body portion and said handle portion with a number of predetermined body parts; and
(c) instructing the user to maneuver said handled massager body in a prescribed manner to effect said body exercise and massaging for the user.

11. The method of exercising and massaging of claim 10 further comprises:
(d) providing, at said handle portion, an elastically extendable end attachment means for removably attaching a first end of at least one flexible linking member thereto wherein a second end of said at least one flexible linking member further comprises an external object-engaging means for, upon its engagement with a predetermined body part or an external object in a prescribed manner, facilitating additional body exercise and massaging;
(e) attaching a first end of said at least one flexible linking member to said elastically extendable end attachment means;
(f) engaging said body portion with a number of predetermined body parts and engaging said external object-engaging means with either a number of predetermined body parts or an external object; and
(g) instructing the user to maneuver said handled massager body together with said flexible linking member and said external object-engaging means in a prescribed manner to effect additional body exercise and massaging for the user.

12. The method of exercising and massaging of claim 11 further comprises:
(h) providing, at said handle portion, a number of selectable elastically extendable end attachment means, each exhibiting a corresponding desired range of elasticity, for removably attaching a first end of at least one flexible linking member thereto wherein a second end of said at least one flexible linking member further comprises an external object-engaging means for, upon its engagement with a predetermined body part or an external object in a prescribed manner, facilitating additional body exercise and massaging
whereby effect said additional body exercise and massaging with a wide range of intensity.

13. The method of exercising and massaging of claim 11 further comprises:
(d1) at the free end of each of said elastically extendable end attachment means, providing an eye loop for attaching the first end of said at least one flexible linking member;
(d2) making said elastically extendable end attachment means rotatable with respect to said handled massager body around its longitudinal axis; and
(d3) instructing the user to position said handled massager body upon a body part and to maneuver said eye loops to massage the body part with a resulting rolling movement of said handled massager body.
